(19) United States
(12) Patent Application Publication
(10) Pub. No.: US 2018/0297184 A1
(43) Pub. Date: Oct. 18, 2018

(54) TORQUE LIMITER

(71) Applicant: NN, Inc., Johnson City, TN (US)

(72) Inventors: Aaron Mathew Bailey, Round Rock, TX (US); Matthew Cohn, Orange, CT (US); Kevin Kolka, Waterford, CT (US); John Kollar, Fairfield, CT (US); James M. Walsh, Naperville, IL (US); Rick Fu, Quincy, MA (US); Robert Bayer Hanspeter, Meriden, CT (US)

(21) Appl. No.: 15/951,405

(22) Filed: Apr. 12, 2018

Related U.S. Application Data
(60) Provisional application No. 62/485,134, filed on Apr. 13, 2017.
(60) Provisional application No. 62/551,335, filed on Aug. 29, 2017.

(51) Int. Cl. B25B 23/142; F16D 7/00; F16D 7/02

(52) U.S. Cl. CPC B25B 23/1427; F16D 7/022; F16D 7/024; F16D 7/005

(57) ABSTRACT

A torque limiter assembly is provided and has a fixed torque member having a plurality of first retainers, a floating torque member having a plurality of second retainers, a plurality of torque transfer members between the first torque member and the floating torque member, and a shaft. A plurality of longitudinal transfer members are provided between the floating torque member and the shaft. The longitudinal transfer members rotationally fix the floating torque member to the shaft, but allow axial movement of the floating torque member. A spring member provides a force on the floating torque member to, at times, rotationally fix the floating torque member to the fixed torque member. A locking mechanism is used to adjust the force of the spring member on the floating torque member.

### CROSS-REFERENCE TO RELATED APPLICATIONS

This application claims the benefit of U.S. Provisional Patent Application No. 62/485,134, filed Apr. 13, 2017, and, U.S. Provisional Patent Application No. 62/551,335, filed Aug. 29, 2017, both of which are expressly incorporated herein by reference and made a part hereof.

### FEDERALLY SPONSORED RESEARCH OR DEVELOPMENT

Not Applicable.

### TECHNICAL FIELD

The present invention relates generally to a tool used to rotate fasteners, and more specifically to a torque limiting mechanism having a preset torque setting for use with these types of tools.

### SUMMARY

According to one embodiment, the disclosed subject technology relates to a torque limiter assembly. The torque limiter assembly may be incorporated into a medical device, including a single-use medical device.

The disclosed subject technology further relates to a torque limiter assembly comprising: a housing; a fixed torque member having a plurality of first retainers; a floating torque member having a plurality of second retainers; a plurality of torque transfer members between the first torque member and the floating torque member, the torque transfer members at least partially seated at times in the first and second retainers; a shaft; a plurality of longitudinal transfer members between the floating torque member and the shaft, the longitudinal transfer members rotationally fixing the floating torque member to the shaft but allowing axial movement of the floating torque member; a spring member providing a force on the floating torque member to, at times, rotationally fix the floating torque member to the fixed torque member; and, a locking mechanism to adjust the force of the spring member on the floating torque member.

The disclosed subject technology further relates to a torque limiter assembly comprising: a housing; a first torque member having a plurality of first retainers; a second torque member having a plurality of second retainers; and, a plurality of rotatable torque transfer members between the first torque member and the second torque member, the rotatable torque transfer members at least partially seated at times in the first and second retainers, wherein the rotatable torque transfer members are tapered and have a first diameter at a first end thereof and a second diameter at an opposing end thereof, and wherein the second diameter is larger than the first diameter.

The disclosed subject technology further relates to a torque limiter assembly comprising: a fixed torque member; a floating torque member adjacent the fixed torque member; a shaft; and, a plurality of longitudinal transfer members between the floating torque member and the shaft, the longitudinal transfer members rotationally fixing the floating torque member to the shaft but allowing axial movement of the floating torque member.

The disclosed subject technology further relates to a torque limiter assembly, wherein the torque transfer members comprise tapered cylindrical members. In one embodiment, the tapered cylindrical members have a first diameter at a first end of the cylindrical member and a second diameter at an opposing end of the cylindrical member, and the second diameter is larger than the first diameter.

The disclosed subject technology further relates to a torque limiter assembly, wherein the torque transfer members comprise ball bearings.

The disclosed subject technology further relates to a torque limiter assembly, wherein the shaft extends through the fixed torque receiver and the floating torque receiver.

The disclosed subject technology further relates to a torque limiter assembly, wherein the shaft has an axial groove to seat the longitudinal transfer members.

The disclosed subject technology further relates to a torque limiter assembly, wherein the spring member comprises a plurality of force-generating members. In one embodiment, the force-generating members comprise Belleville washers. In another embodiment, the spring member comprises a compression spring.

The disclosed subject technology further relates to a torque limiter assembly, wherein the second retainers of the floating torque member have a helical ramp entrance thereto.

The disclosed subject technology further relates to a torque limiter assembly, wherein the torque transfer members are rotatable between the fixed torque member and the floating torque member.

The disclosed subject technology further relates to a torque limiter assembly, wherein the first retainers are integral with the housing.

The disclosed subject technology further relates to a torque limiter assembly, wherein the first torque member is fixed to the housing and wherein the second torque member is capable of moving axially with respect to the housing.

The disclosed subject technology further relates to a torque limiter assembly further comprising: a shaft; a plurality of longitudinal transfer members between the second torque member and the shaft, the longitudinal transfer members rotationally fixing the second torque member to the shaft but allowing axial movement of the second torque member; a spring member providing a force on the second torque member to, at times, rotationally fix the second torque member to the first torque member; and, a locking mechanism to adjust the force of the spring member on the second torque member.

The disclosed subject technology further relates to a torque limiter assembly, wherein the longitudinal transfer members comprise ball bearings, wherein the shaft has an external longitudinal groove to partially seat the longitudinal transfer members, and wherein the floating torque member has at least one internal longitudinal groove to partially receive the longitudinal transfer members.

The disclosed subject technology further relates to a torque limiter assembly, wherein the fixed torque member has a plurality of first retainers, and wherein the floating torque member has a plurality of second retainers.

The disclosed subject technology further relates to a torque limiter assembly, further comprising a plurality of torque transfer members between the first torque member and the floating torque member, the torque transfer members at least partially seated at times in the first and second retainers.

The disclosed subject technology further relates to a torque limiter assembly, further comprising a spring member providing a force on the floating torque member to, at times, rotationally fix the floating torque member to the fixed torque member, and a locking mechanism to adjust the force of the spring member on the floating torque member.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present invention, it will now be described by way of example, with reference to the accompanying drawings in which:

FIG. 1 is a rear perspective view of one embodiment of a torque limiter.

FIG. 2 is a cross-sectional side view of the torque limiter of FIG. 1.

FIG. 3 is a cross-sectional view of the front cap of the torque limiter of FIG. 1, showing a receiver of the front cap.

FIG. 4 is a cross-sectional view of the torque limiter of FIG. 1, showing a first end of the floating torque member and ball bearings for engagement with the receiver of the front cap.

FIG. 5 is a cross-sectional view of the floating torque member of FIG. 7.

FIG. 6 is an exploded view of the torque limiter of FIG. 1 with a portion of the sidewall of the front cap removed to show the receiver of the front cap.

FIG. 7 is a cross-sectional side view of another embodiment of the torque limiter.

FIG. 8 is a cross-sectional view of the retainer bearing of the torque limiter of FIG. 7.

FIG. 9 is a cross-sectional view of the front cap of the torque limiter of FIG. 7, showing a fixed receiver connected to the front cap.

FIG. 10 is a cross-sectional view of the torque limiter of FIG. 7, showing a first end of the floating torque member and ball bearings for engagement with the fixed receiver in the front cap.

FIG. 11 is a cross-sectional view of the floating torque member of FIG. 10.

FIG. 12 is an exploded view of the torque limiter of FIG. 7.

FIG. 13 is a front perspective view of another embodiment of a torque limiter.

FIG. 14 is a cross-sectional side view of the torque limiter of FIG. 13.

FIG. 15 is an exploded view of the torque limiter of FIG. 13.

FIG. 16 is a perspective view of the front cap of the torque limiter of FIG. 13 with a portion of the sidewall of the front cap removed to show the receiver housing of the front cap.

FIG. 17 is a front perspective view of the floating torque member of FIG. 13.

FIG. 18 is a rear perspective view of the fixed disc for the torque limiter of FIG. 13.

FIG. 19 is a front perspective view of the alternate floating torque member of FIG. 17.

FIG. 20 is a rear perspective view of the alternate fixed disc of FIG. 18.

FIG. 21 is a rear perspective view of another embodiment of a torque limiter.

FIG. 22 is a cross-sectional side view of the torque limiter of FIG. 21.

FIG. 23 is an exploded view of the torque limiter of FIG. 21.

FIG. 24 is a front perspective view of another embodiment of a torque limiter.

FIG. 25 is a cross-sectional side view of the torque limiter of FIG. 24.

FIG. 26 is a cross-sectional view of the torque limiter of FIG. 24, showing a first end of the floating torque member and ball bearings for engagement with the receiver of the front cap.

FIG. 27 is a cross-sectional view of the front cap of the torque limiter of FIG. 24, showing a receiver of the front cap.

FIG. 28 is a cross-sectional view of the floating torque member of FIG. 24.

FIG. 29 is an exploded view of the torque limiter of FIG. 24.

FIG. 30 is a front perspective view of the floating torque member of FIG. 24.

FIG. 31 is a front perspective view of another embodiment of a torque limiter.

FIG. 32 is a cross-sectional side view of the torque limiter of FIG. 31.

FIG. 33 is a cross-sectional view of the torque limiter of FIG. 31, showing a first end of the floating torque member and tapered pins for engagement with the fixed receiver in the front cap.

FIG. 34 is a cross-sectional view of the front cap of the torque limiter of FIG. 31.

FIG. 35 is a cross-sectional view of the floating torque member of FIG. 31.

FIG. 36 is an exploded view of the torque limiter of FIG. 31.

FIG. 37 is a rear perspective view of the floating torque member for the torque limiter of FIG. 31.

FIG. 38 is a front perspective view of the floating torque member of FIG. 31.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring now to the Figures, there is shown a variety of embodiments of a torque limiter assembly 10 in which like reference numerals, or like reference numerals in a different series (e.g., 100 series, 200 series, etc.) designate like components throughout the disclosure. The torque limiter assembly assists in limiting the amount of torque applied to a fastener by the torque limiter. Preferably, the maximum amount of torque the torque limiter is able to apply is preset during assembly of the torque limiter. The torque limiter tool can be virtually any type of hand-held or power-driven tool that is used to apply torque to a driven member, e.g., a fastener, but in a preferred embodiment is a hand-held torque wrench.

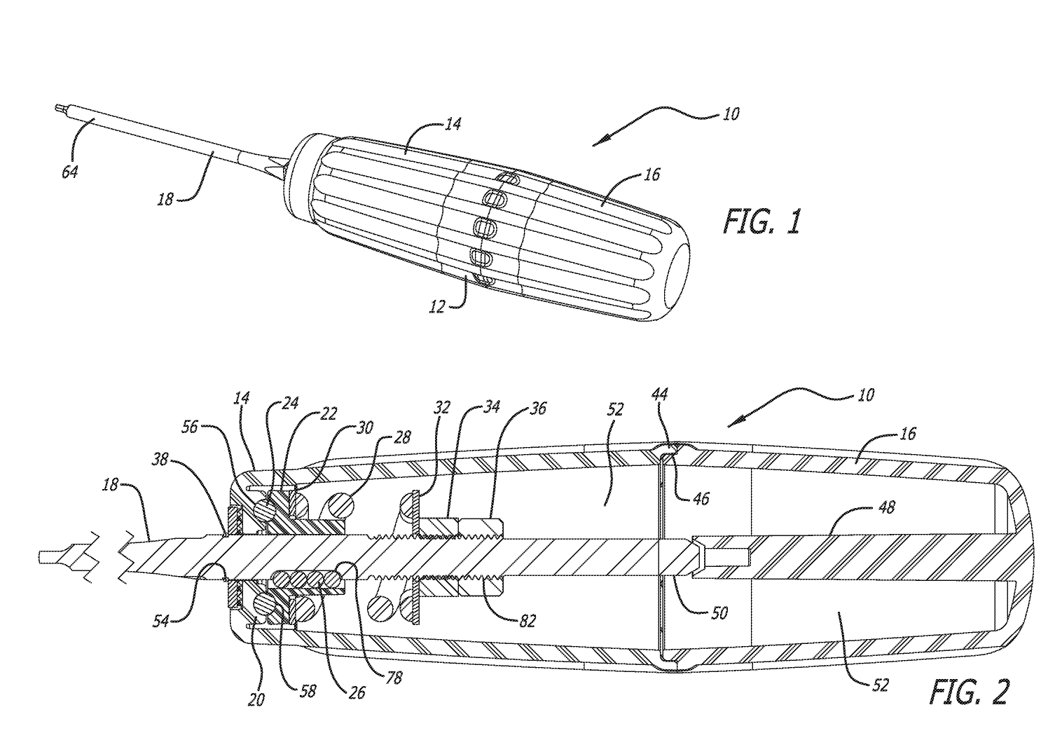

One embodiment of a torque limiter 10 is shown in FIGS. 1-6. Referring to FIG. 6, in one embodiment the torque limiter 10 generally comprises an impactor housing 12, which may comprise a front housing 14 and a rear housing 16, a shaft 18, a fixed torque receiver 20 (also referred to herein throughout and in the claims as a fixed torque member 20 and a first torque member 20), a floating torque member 22 (also referred to herein throughout and in the claims as a second torque member 22 and a fixed torque receiver 20), a plurality of torque transfer members 24, such as ball bearings 24, a plurality of longitudinal transfer member 26, such as ball bearings 26, that are positioned between the floating torque member 22 and the shaft 18, a spring member 28, which in one embodiment is a compression spring 28, a first retainer 30 on one end of the spring member 28 and a second retainer 32 on the opposing end of the spring member 28, a first locking member or nut 34, a second or locking/jam nut 36, a retaining ring 38, and a first thrust washer 40. In one embodiment the first thrust washer 40 is a metal washer, such as stainless steel. In an alternate embodiment a second thrust washer 42 is provided. To the extent a second thrust washer 42 is used, it may similarly be made of metal, or it may be a low friction high strength polymer.

In one embodiment the impactor housing 12 is a handle for the overall tool 10. In one embodiment the handle comprises a front housing 14 that is connected to a rear housing 16. As shown in FIG. 6, one of the front housing 14 or the rear housing 16 may have a plurality of mating members 44, such as protrusions 44, and the other of the front housing 14 or the rear housing 16 may have mating receivers 46 to receive and assist in securing the front housing 14 to the rear housing 16. The rear housing 16 may also have an internal protrusion 48 for engaging a second end 50 of the shaft 18 to assist in properly positioning the shaft 18. Alternate connection means between the front and rear housings 14, 16 may be provided. Additionally, the impactor housing 12 may be made of different construction than a front and rear housing 14, 16, such as a clam shell structure or a single unitary structure. Further alternate constructions are also possible. Preferably the housing 12 is formed of a suitably rigid, but generally lightweight material, such as metal or plastic.

In several embodiments, the shaft 18 is generally the drive body that applies the torque to the fastener, or to further structure as disclosed herein that may be connected to the fastener. The input torque is generally provided to the shaft 18 via its connection to the handle 12, which is generally turned by the user or to which torque is applied via a separate drive mechanism. The shaft 18 may be held in place with respect to the housing 12 via a variety of mechanisms. For example, in one embodiment the shaft 18 is held axially or laterally from inward motion into the cavity 52 of the housing 12 via the retaining ring 38 that is fixed to the shaft 18 and positioned in a groove 55 in the shaft 18. The shaft 18 is further held in place from axial or lateral movement out of the cavity 52 through the opening 54 in the front housing 14 via the torque mechanism as described herein.

In one embodiment the torque mechanism generally comprises the fixed torque receiver 20 that is fixedly connected to the front housing 14, the floating torque member 22, the plurality of torque transfer members 24, the plurality of longitudinal transfer member 26, the spring member 28, and the locking member 34. As shown in FIG. 6, in one embodiment the fixed torque receiver 20 is integral with and made as a part of the front housing 14. In alternate embodiments the fixed torque receiver 20 may be a separate component from the front housing 14 that is connected to the front housing 14. In a preferred embodiment the fixed torque receiver 20 is rotationally and axially locked to the front housing 14, such that as the front housing 14 is rotated the fixed torque receiver 20 is similarly rotated, and there is preferably little or no relative rotation between the fixed torque receiver 20 and the front housing 14. Similarly, in a preferred embodiment there is preferably little or no relative axial movement between the fixed torque receiver 20 and the front housing 14.

In a preferred embodiment the connection between the fixed torque receiver 20 and the floating torque member 22 is made via a plurality of torque transfer members 24, such as ball bearings 24. In a preferred embodiment the torque transfer members 24 are round or spherical bodies. Accordingly, in a preferred embodiment the fixed torque receiver 20 includes a plurality of retainers or receivers 56 for retaining the torque transfer members 24. Similarly, the floating torque member 22 includes a plurality of retainers or receivers 58 for retaining the torque transfer members 24. In one embodiment the retainers 56 are provided in an annular configuration at a fixed radial distance from a center of the fixed torque receiver 20. Similarly, the retainers 58 of the floating torque member 22 are preferably provided in the same annular configuration at the same fixed radial distance from a center of the floating torque member 22. The torque transfer members 24 are therefore retained between the fixed torque receiver 20 and the floating torque receive 22 with the respective retainers 56, 58.

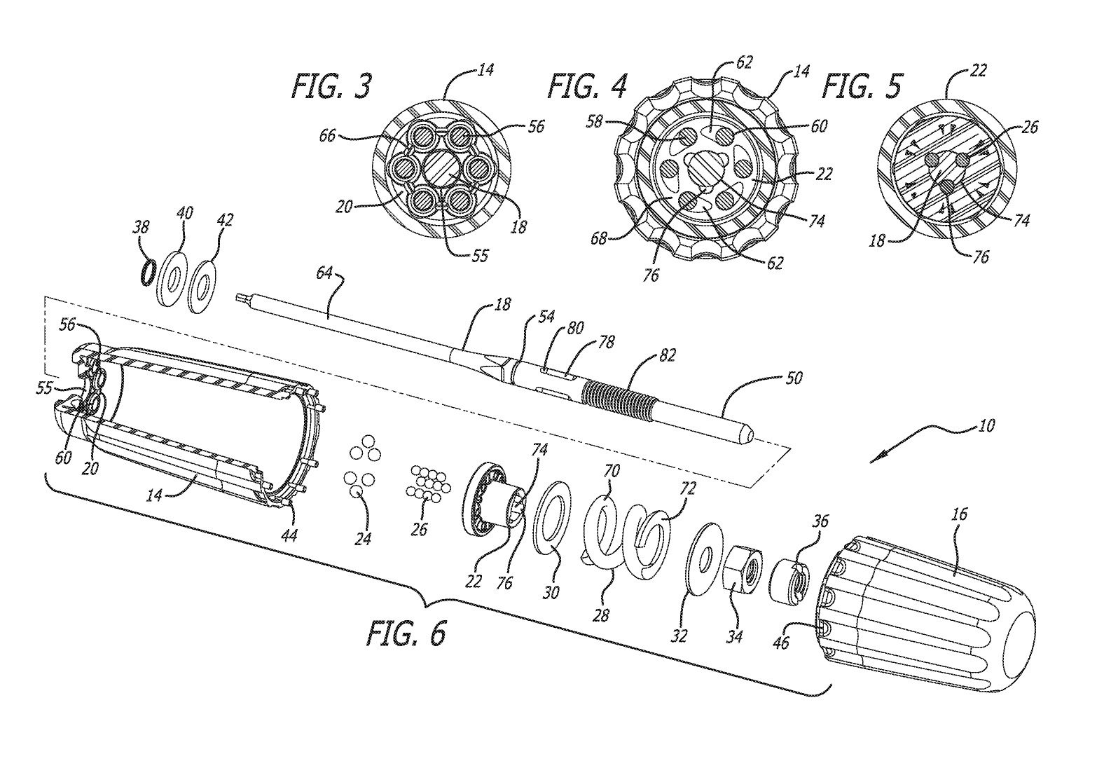

Referring to FIG. 3, in one embodiment the retainers 56 of the fixed torque receiver 20 generally comprise a mating semi-spherical shape, such as half or less of an overall sphere, to seat the torque transfer members 24. The seating of the torque transfer members 24 in the retainers 56 of the fixed torque receiver 20, including the cross-sectional shape of one embodiment of the retainers 56 and the torque transfer members 24 is further seen in cross-section in FIG. 2. The retainers 58 of the floating torque member 22 may have a similar geometry to the retainers 56 of the fixed torque receiver 20. Alternately, the retainers 58 of the floating torque member 22 may have a partially similar geometry and a partially dissimilar geometry to the geometry of the retainers 56 of the fixed torque receiver 20. For example, as shown in the embodiment of FIG. 4, the retainers 58 of the floating torque member 22 may have a spherical shape component 60 and an entrance portion 62 to the spherical shape component 60 of the retainer 58. In a preferred embodiment the entrance portion 62 of the retainer 58 of the floating torque member 22 may have a tear drop or helical ramp shape about the annular geometry in which the retainers 58 are positioned. As explained herein, the helical ramp shape of the entrance portion 62 of the retainers 58 allows for a smoother entrance of the torque transfer members 24 into the retainers 58 of the floating torque member 22.

In a preferred embodiment, the spring member 28 provides a force to push the floating torque member 22 toward the fixed torque receiver 20 and to maintain the floating torque member 22 rotationally fixed to the fixed torque receiver 20 with the use of the torque transfer members 24, absent a resistant torque or force on the drive shaft 18 greater than the force applied by the spring member 28 on the floating torque member 22. As seen in FIG. 2, when no resistance force is being applied to the output end 64 of the drive shaft 18, the spring member 28 provides a force to rotationally lock the floating torque receiver 22 to the fixed torque receiver 20. In this normal or unactuated position, an exterior surface 66 of the fixed torque receiver 20 may be adjacent or contacting an exterior surface 68 of the floating torque member 22. In one embodiment a first retainer 30, which may be a washer, is provided at a first end 70 of the spring member 28 and between the floating torque member 22 and the spring member 28, and a second retainer 32, which may also be a washer, is provided at a second end 72 of the spring member 28 and between the spring member 28 and the first locking member 34.

In a preferred embodiment, the floating torque member 22 is rotationally fixed to the shaft 18, but is not axially locked to the shaft 18 such that axial movement of the floating torque member 22 relative to the shaft 18 is possible. In one embodiment, the ability for such relative axial movement of the floating torque member 22 with respect to the shaft 18 is provided by longitudinal transfer members 26 provided between the floating torque member 22 and the shaft 18. In a preferred embodiment the floating torque member 22 has a central bore 74 through which the shaft 18 is able to extend. As shown in FIGS. 4-6, the central bore 74 of the floating torque member 22 further has a plurality of axial grooves 76 to seat a portion of the longitudinal transfer members 26. Similarly, in a preferred embodiment the shaft 18 has a plurality of axial grooves 78 to seat a portion of the longitudinal transfer members 26. In one embodiment there are three axial grooves 76 rotationally positioned every 120° around the inner circumference of the central bore 74 of the floating torque member 22, and there are three axial grooves 78 rotationally positioned every 120° around the outer circumference of the shaft 18. While the shaft 18 is illustrated as having a circular circumference, alternate geometries, such as for example, an octagon, are acceptable. Similarly, while the central bore 74 of the floating torque member 22 is shown as being circular, other geometries are similarly acceptable. Additionally, the axial grooves 78 in the shaft 18 may have a lead in 80 to allow for seating the longitudinal transfer members 26 within the axial grooves 78. Accordingly, as shown in FIG. 5, because a portion of the longitudinal transfer members 26 are seated in the axial grooves 76 in the floating torque member 26 and a portion of the longitudinal transfer members 26 are seated in the axial grooves 78 in the shaft 18, the floating torque member 26 is rotationally locked to the shaft 18, but the floating torque member 26 is able to slide axially with respect to the shaft 18.

As shown in FIG. 6, in one embodiment the shaft 18 has threads 82 to engage mating threads on the locking members 34, 36, as shown in FIG. 2. By threading the locking member 34 on the shaft 18 and axially moving the locking member 34 toward the fixed torque receiver 20 the spring member 28 is compressed between the locking member 34 and the floating torque member 22, and the force setting or torque of the overall torque mechanism can be set. In one embodiment the first locking member 34 is a nut. The further the locking member 34 is moved toward the fixed torque receiver 20 to further compress the spring member 28, the greater the force operating to maintain the floating torque member 22 in rotational engagement with the fixed torque receiver 20, and the higher the torque rating of the torque limiter tool 10. Accordingly, the torque rating of the torque limiter tool 10 can be adjusted between a variety of torque ratings, and thus can be preset during assembly of the torque limiter tool 10. Once the first locking member 34 is set in its proper position and the torque rating of the torque limiter tool 10 is properly set, the second locking member 36, also referred to in some embodiments as a jam nut 36 can be rotated against the first locking member 34 to lock against the first locking member and set the position of the first locking member 34 so that the first locking member 34 preferably does not move, which would alter the torque rating of the torque limiter tool 10. Additionally, in this embodiment, after the first and second locking members 34, 36 are properly positioned, the rear housing 16 can be connected to the front housing 14 to form the completed impactor housing 12.

In use, in this embodiment, the output end 64 of the drive shaft 18 is put into engagement with a fastener (not shown), such as, for example, a screw to be inserted into a medical implant. The output end 64 of the drive shaft 18 may have any mating geometry required to mate with the fastener. To prevent the screw from being over-turned/over-rotated/over-torqued and possibly damaging the implant, a torque limiting tool 10 of the present disclosure is provided that is preset such that the maximum torque that can be applied by the tool 10 is less than the torque that could over-turn/over-rotate/over-torque the fastener and therefore possibly damage the implant.

To rotate the fastener and therefore set the fastener into the implant, in this example, the user engages the fastener with the output end 64 of the drive shaft 18 of the tool 10. The user then rotates the tool 10 by rotating the handle 12 of the tool 10 via applying a rotational force to the handle 12 of the tool 10. As explained supra, in a preferred embodiment the handle 12 is rotationally and axially locked to the fixed torque receiver 20. Similarly, until the resistance force/torque applied to the tool 10 from the fastener exceeds the preset torque rating of the torque limiting tool 10, the fixed torque receiver 20 is rotationally locked to the floating torque member 22 with the plurality of torque transfer members 24 via the spring force applied to the floating torque member 22 from the spring member 28. And, the floating torque member 22 is rotationally locked to the shaft 18 via the longitudinal transfer members 26 between the shaft 18 and the floating torque member 22. Therefore, rotation of the handle 12 causes rotation of the fixed torque receiver 20, which in turn causes simultaneous rotation of the floating torque member 22, which in turn causes simultaneous rotation of the shaft 18, including rotation of the output end 64 of the shaft 18. When the shaft 18 is rotated the fastener will similarly be rotated, such as for example, to rotate or screw the fastener into the implant.

During rotation of the fastener into the implant the torque limiter tool 10 applies a torque to the fastener through the drive shaft 18 of the torque limiter tool 10. As the torque is applied by the torque limiter tool 10, a resistance force is observed by the torque limiter tool 10. When the resistance force requires the torque limiter tool 10 to exceed the torque rating of the torque limiter tool 10, the floating torque member 22 will disengage from the fixed torque member 20. Continued rotation of the handle 12 by the user, which equates to an input torque force, will cause the torque transfer members 24 positioned in the retainers 56 of the fixed torque receiver 20 to become displaced from their position in the retainers 58 of the floating torque member 22, thereby causing the floating torque member 22 to axially move toward the locking member 34 by compressing the spring member 28. The spring member 28 will only be compressed, i.e., the floating torque member 22 will only move axially toward the locking member 34, when the torque being applied to the fastener by the torque limiter tool 10 exceeds the amount of force applied by the spring member 28 to maintain the floating torque member 22 in rotational engagement with the fixed torque receiver 20. When the torque transfer members 24 are displaced from their position in the retainers 58 of the floating torque member 22, they are still retained by the retainers 56 in the fixed torque receiver 20. Whereas the floating torque member 22 is maintained rotationally fixed by the torque force applied by the fastener to the shaft 18, the fixed torque receiver 20 and torque transfer member 24 rotate with the handle 12 due to the force being applied from the user. The torque transfer members 24 will rotate with the fixed torque receiver 20 and at some rotational point will engage the entrance portion 62 of the adjacent retainer 58 of the floating torque member 22. The helical ramp shape of the entrance portion 62 of the retainers 58 allows for a smoother entrance of the torque transfer members 24 into the retainers 58 of the floating torque member 22 so that the user of the torque transfer tool 10 does not experience a jarring force as the torque transfer members 24 engage the adjacent retainers 58 in the floating torque member 22. However, the user will hear an audible click to recognize that the rotational torque being applied by the user to the torque transfer tool 10 has exceeded the rating of the tool 10 and further rotation should be stopped (i.e., the fastener is properly set).

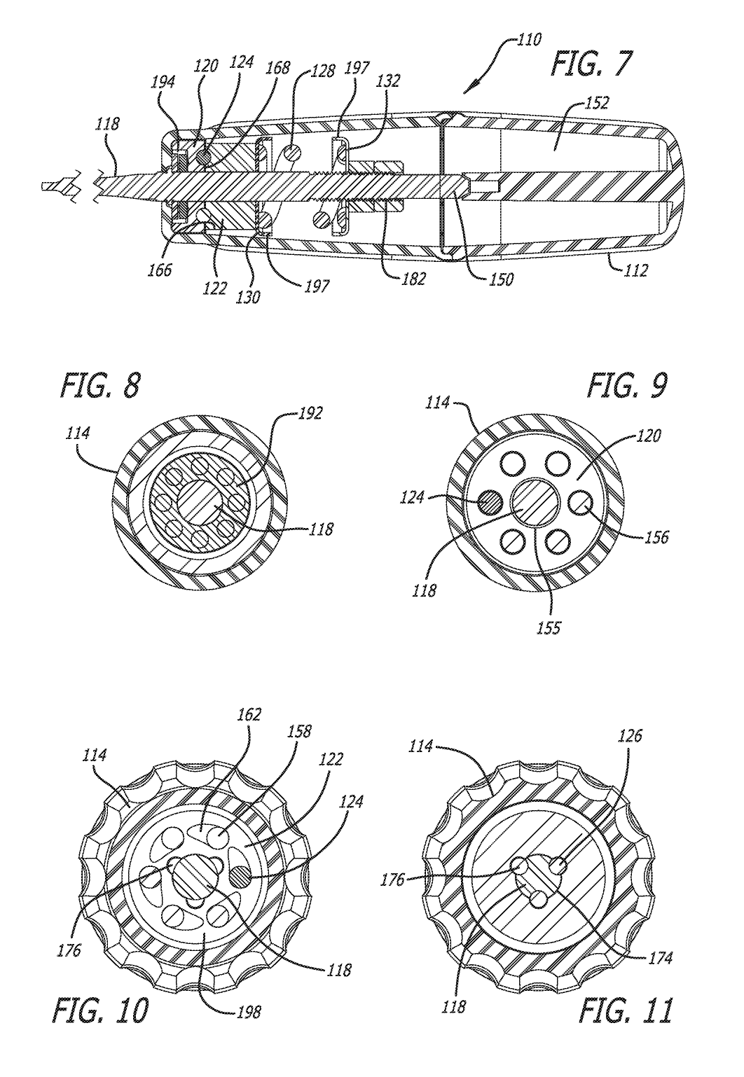

Another embodiment of a torque limiting tool 110 is illustrated in FIGS. 7-12. Many of the components of the first embodiment of FIGS. 1-6 are similarly incorporated in this embodiment, however, certain modifications are also incorporated. Like components from the first embodiment will have like 100 series reference numbers in this embodiment in the figures and the specification.

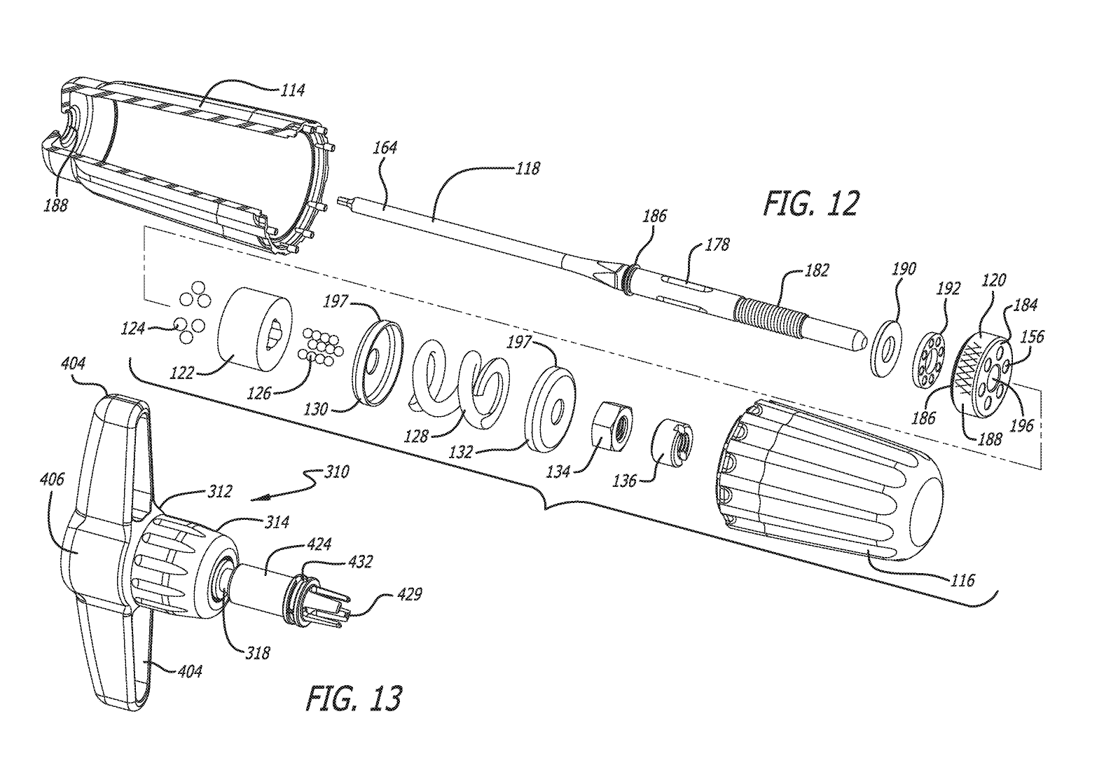

Referring to FIGS. 7 and 12, the fixed torque receiver 120 is not integral with the front housing 114, but rather is a separate component that is rotationally and axially fixed to the front housing 114. The fixed torque receiver 120 of this embodiment may be a metal or plastic component, depending on the forces seen by the fixed torque receiver via the torque transfer members 24. In one embodiment the fixed torque receiver 120 is a disc-like member having a first surface 184, a second surface 186 and an exterior sidewall 188 therebetween. The exterior sidewall 188 may have surface irregularities, such as a knurl, that assist the fixed torque receiver 120 in being rotationally and axially fixed to the front housing 114. Alternate assembly methods, such as using an adhesive, ultrasonic welding, etc., may be used to rotationally and axially fix the fixed torque receiver 120 to the front housing 114. In one embodiment the retainers 156 of the fixed torque receiver are provided in the first surface 184 of the fixed torque receiver 120.

As shown in FIGS. 7, 8, and 12, instead of employing a retaining ring 38 to prevent axial movement of the shaft 118, the shaft 118 may have a shoulder 186 that engages a recess 188 in the front housing 114 on one side of the shoulder 186, and a thrust washer 190 on the other side the shoulder 186. In one embodiment, the thrust washer 190 may engage a bearing 192 seated in a recess 194 in the second surface 186 of the fixed torque receiver 120. The bearing 192 allows the shaft 118 to rotate without impingement by the fixed torque receiver 120. The fixed torque receiver 120 also has a central bore 196 through which the shaft 118 extends.

Additional modifications of this embodiment include that retainers 130, 132 on the opposing sides of the spring member 128 have flanges 197 to assist in retaining and properly seating the spring member 128 on the shaft 118. And, the floating torque member 122 of this embodiment may have a consistent thickness from the first surface 198 of the floating torque member 122, where the retainers 158 are provided, to the second surface 199 that contacts the retainer 130.

Use of this embodiment of the torque limiting tool 110 is similar to the use of the torque limiting tool 10 of the prior embodiment. For example, in the example where the fastener is a screw and the screw is being screwed into an implant, to rotate the fastener and therefore set the fastener into the implant, in this example, the user engages the fastener with the output end 164 of the drive shaft 118 of the tool 110. The user then rotates the tool 110 by rotating the handle 112 of the tool 110 via applying a rotational force to the handle 112 of the tool 110. As explained supra, even though the fixed torque receiver 120 is a separate component from the handle 112, in this embodiment the handle 112 is rotationally and axially locked to the fixed torque receiver 120. Similarly, until the resistance force/torque applied to the tool 110 from the fastener exceeds the preset torque rating of the torque limiting tool 110, the fixed torque receiver 120 is rotationally locked to the floating torque member 122 with the plurality of torque transfer members 124 via the spring force applied to the floating torque member 122 from the spring member 128. And, the floating torque member 122 is rotationally locked to the shaft 118 via the longitudinal transfer members 126 between the shaft 118 and the floating torque member 122. Therefore, rotation of the handle 112 causes rotation of the fixed torque receiver 120, which in turn causes simultaneous rotation of the floating torque member 122, which in turn causes simultaneous rotation of the shaft 118, including rotation of the output end 164 of the shaft 118. Therefore, when the shaft 118 is rotated the fastener will similarly be rotated, such as for example, to rotate or screw the fastener into the implant.

During rotation of the fastener into the implant the torque limiter tool 110 applies a torque to the fastener through the drive shaft 118 of the torque limiter tool 110. As the torque is applied by the torque limiter tool 110, a resistance force is observed by the torque limiter tool 110. When the resistance force requires the torque limiter tool 110 to exceed the torque rating of the torque limiter tool 110, the floating torque member 122 will disengage from the fixed torque member 120. Continued rotation of the handle 112 by the user, which equates to an input torque force, will cause the torque transfer members 124 positioned in the retainers 156 of the fixed torque receiver 120 to become displaced from their position in the retainers 158 of the floating torque member 122, thereby causing the floating torque member 122 to axially move toward the locking member 134 by compressing the spring member 128. The spring member 128 will only be compressed, i.e., the floating torque member 122 will only move axially toward the locking member 134, when the torque being applied to the fastener by the torque limiter tool 110 exceeds the amount of force applied by the spring member 128 to maintain the floating torque member 122 in rotational engagement with the fixed torque receiver 120. When the torque transfer members 124 are displaced from their position in the retainers 158 of the floating torque member 122, they are still retained by the retainers 156 in the fixed torque receiver 120. Whereas the floating torque member 122 is maintained rotationally fixed by the torque force applied by the fastener to the shaft 118, the fixed torque receiver 120 and torque transfer member 124 rotate with the handle 112 due to the force being applied from the user. The torque transfer members 124 will rotate with the fixed torque receiver 120 and at some rotational point will engage the entrance portion 162 of the adjacent retainer 158 of the floating torque member 122. The helical ramp shape of the entrance portion 162 of the retainers 158 allows for a smoother entrance of the torque transfer members 124 into the retainers 158 of the floating torque member 122 so that the user of the torque transfer tool 110 does not experience a jarring force as the torque transfer members 124 engage the adjacent retainers 158 in the floating torque member 122. However, the user will hear an audible click to recognize that the rotational torque being applied by the user to the torque transfer tool 110 has exceeded the rating of the tool 110 and further rotation should be stopped (i.e., the fastener is properly set).

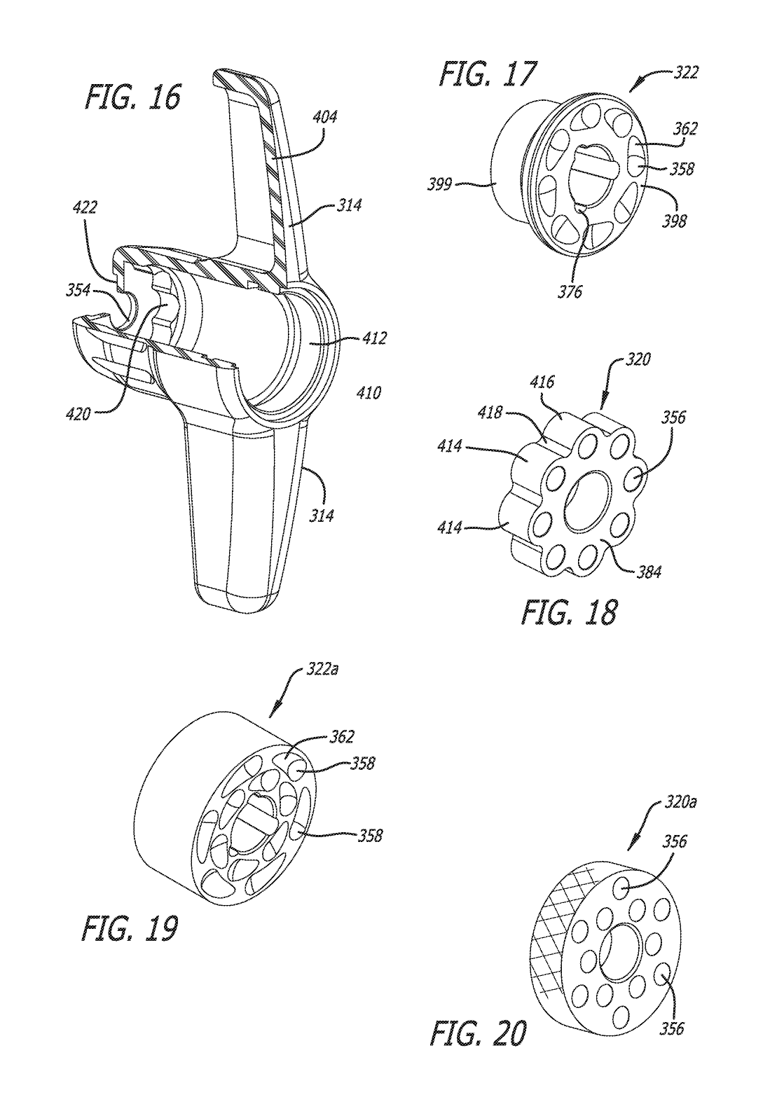

Another embodiment of a torque limiting tool 310 is illustrated in FIGS. 13-20. Many of the components of the first embodiment of FIGS. 1-6 and/or second embodiment of FIGS. 7-12 are similarly incorporated in this embodiment, however, certain modifications are also incorporated. Like components from the first and second embodiments will have like 300 series reference numbers in this embodiment in the figures and the specification.

Referring to FIGS. 13-16, the impactor housing 312 of the torque limiter tool 310 comprises a front housing 314 and a rear housing 316, however, the front housing 314 has arms 404 extending from the sidewall 406 of the front housing 314. In various uses, the arms 404 assist in rotating the housing 312 to screw in a fastener. Additionally, the rear housing 316 in this embodiment is a cap 316 that has spring arms 408 that engage a groove 410 in the inner wall 412 of the front housing 314 to secure the rear housing 316 to the front housing 314.

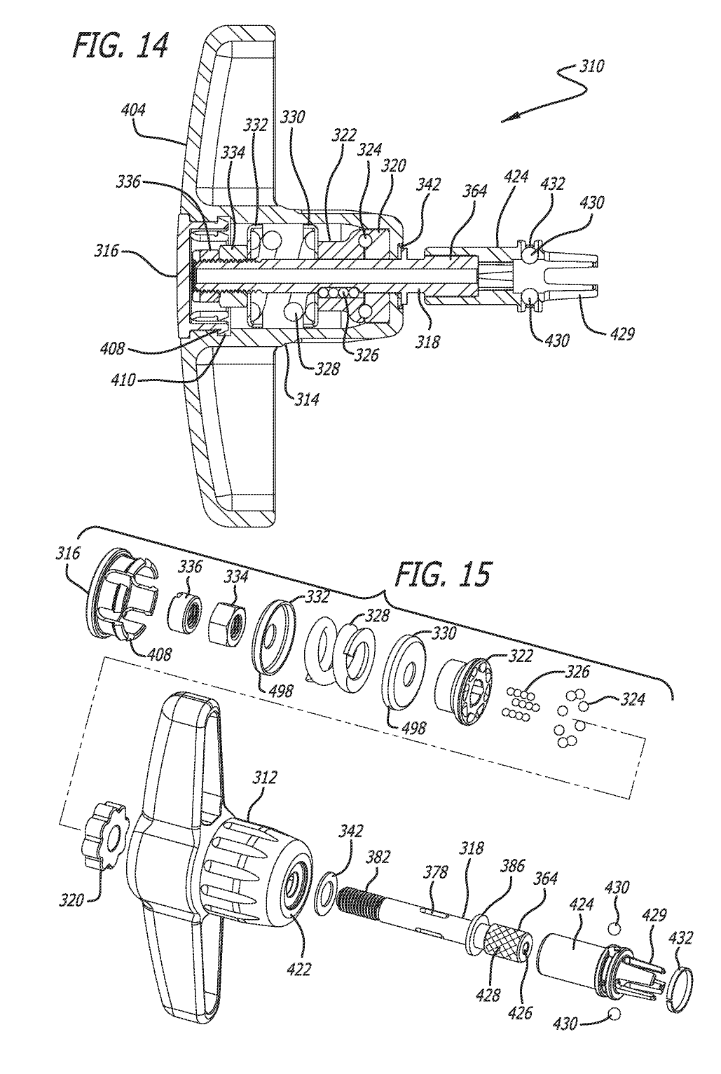

Referring to FIGS. 14-16 and 18, the fixed torque receiver 320 of this embodiment is also not integral with the front housing 314, but rather is a separate component that is rotationally and axially fixed to the front housing 314. The fixed torque receiver 320 of this embodiment may be a metal or plastic component, depending on the forces seen by the fixed torque receiver via the torque transfer members 324. In one embodiment the fixed torque receiver 320 is a disc-like member having a first surface 384, a second surface 386 and an exterior sidewall 388 therebetween. The exterior sidewall 388 in this embodiment has a plurality of surface irregularities 414, including a plurality of geometrical shapes 414, including a plurality of curved peaks 416 and valleys 418. In one embodiment the geometrical surface irregularities 414 comprise that of a sine wave. Similarly, the inner wall 412 of the front housing 314 adjacent the opening 354 where the fixed torque receiver 320 is connected to the front housing 314 may also have a plurality of mating geometrical shapes 420 to mate with the irregularities 414 of the fixed torque receiver 320, and to assist in precluding rotation of the fixed torque receiver 320 with respect to the front housing 314.

Additionally, similar to the first embodiment as shown in FIG. 2, referring to FIGS. 14-16 of this embodiment, axial or lateral inward motion of the shaft 318 into the cavity 352 of the housing 312 is prevented via a retaining ring 338 that is fixed to the shaft 318 and positioned in a groove 355 in the shaft 318. Like the first embodiment, a plurality of washers 340, 342 may also be employed to assist in retaining the shaft 318 but allowing for rotation of the shaft 318 as in the first embodiment described supra. Alternately, the shaft 318 may have a shoulder 386 in place of a retaining ring 338 to assist in properly positioning the shaft 318. The shaft 318 is further held in place from axial or lateral movement out of the cavity 352 through the opening 354 in the front housing 314 via the torque mechanism as described herein. The front housing 314 may also have a recess 422 to seat the washers 340, 342.

As shown in FIGS. 14, 15 and 17, the floating torque member 322 of this embodiment is similar to the floating torque member 22 of the first embodiment, where the diameter of the floating torque member 322 at the first surface 398 is larger than the diameter of the floating torque member 322 at the second surface 399 that contacts the retainer 330. The diameter of the floating torque member 322 at the first surface 398 must be large enough to have mating retainers 358 for the location of the torque transfer members 324 seated in the retainers 356 in the fixed torque member 320. As shown in FIGS. 14 and 15, in this embodiment the retainers 320, 322 for the spring member 328 have flanges 498 to assist in retaining and properly seating the spring member 328 on the shaft 318 as in the second embodiment.

Another variation in this embodiment is that rather than having the output end 364 of the drive shaft 318 directly engage a fastener, such as, for example, a screw to be inserted into an implant, the output end 364 of the drive shaft 318 may allow for securement of a quick-release member 424 to the drive shaft 318. In one embodiment the quick release member 424 is screwed into a threaded bore 426 at the output end 364 of the drive shaft 318, and in an alternate embodiment the output end 364 of the drive shaft 318 has a knurled surface 428 and the quick release member 424 is pressure fit onto the knurled surface 428 of the drive shaft 318. The quick release member 424 may secure a tool (not shown) thereto, where the tool can then be mated with the fastener manipulating the fastener. By having a quick release member 324 a variety of different tools may be utilized with the same torque limiter tool 310. In one embodiment the quick release member 424 comprises a quick release body 426 having a plurality of fingers 429 to retain the tool, a plurality of ball bearings 430 and a c-clamp 432. By moving the release body 426 the ball bearings 430 can be allowed to move radially outwardly, while still being held by the c-clamp, for insertion and removal of the tool. Then, when the release body 426 is put back in its normal position the ball bearings 430 cannot be moved and the tool will be fixed in place.

Additional alternate components for the fixed torque receiver 320a and the floating torque member 322a are shown in FIGS. 19 and 20. In those alternate embodiments there are extra retainers 356, 358 in the fixed torque receiver 320 and the floating torque member 322a, and corresponding extra torque transfer members 324, as compared with the prior embodiments. In these alternate embodiments, the retainers 356, 358 are provided in two annular circles and alternate between being closer to the center and further from the center as they move radially about the members. Having the additional retainers 356, 358 allows for the transmission of more torque than in other embodiments.

Use of this embodiment of the torque limiting tool 310 is similar to the use of the torque limiting tools 10, 110 of the prior embodiments. For example, in the example where the fastener is a screw and the screw is being screwed into an implant, to rotate the fastener and therefore set the fastener into the implant, in this example, the user engages the fastener with the tool that is placed in the quick release member 424 at the output end 364 of the drive shaft 318 of the torque limiter 310. The user then rotates the torque limiter 310 by rotating the handle 312 of the torque limiter 310 via applying a rotational force to the handle 312. As explained supra, even though the fixed torque receiver 320 is a separate component from the handle 312, in this embodiment the handle 312 is rotationally and axially locked to the fixed torque receiver 320 with the surface irregularities 424 of the fixed torque receiver 320. Similarly, until the resistance force/torque applied to the torque limiter 310 from the fastener through the quick release member 424 exceeds the preset torque rating of the torque limiter 310, the fixed torque receiver 320 is rotationally locked to the floating torque member 322 with the plurality of torque transfer members 324 via the spring force applied to the floating torque member 322 from the spring member 328. And, the floating torque member 322 is rotationally locked to the shaft 318 via the longitudinal transfer members 326 between the shaft 318 and the floating torque member 322. Therefore, rotation of the handle 312 causes rotation of the fixed torque receiver 320, which in turn causes simultaneous rotation of the floating torque member 322, which in turn causes simultaneous rotation of the shaft 318, including rotation of the output end 364 of the shaft 318 and the quick release member 424 connected thereto and tool therein. Therefore, when the shaft 318 is rotated the fastener will similarly be rotated, such as for example, to rotate or screw the fastener into the implant.

During rotation of the fastener into the implant the torque limiter tool 310 applies a torque to the fastener through the drive shaft 318 of the torque limiter tool 310. As the torque is applied by the torque limiter tool 310, a resistance force is observed by the torque limiter tool 310. When the resistance force requires the torque limiter tool 310 to exceed the torque rating of the torque limiter tool 310, the floating torque member 322 will disengage from the fixed torque member 320. Continued rotation of the handle 312 by the user, which equates to an input torque force, will cause the torque transfer members 324 positioned in the retainers 356 of the fixed torque receiver 320 to become displaced from their position in the retainers 358 of the floating torque member 322, thereby causing the floating torque member 322 to axially move toward the locking member 334 by compressing the spring member 328. The spring member 328 will only be compressed, i.e., the floating torque member 322 will only move axially toward the locking member 334, when the torque being applied to the fastener by the torque limiter tool 310 exceeds the amount of force applied by the spring member 328 to maintain the floating torque member 322 in rotational engagement with the fixed torque receiver 320. When the torque transfer members 324 are displaced from their position in the retainers 358 of the floating torque member 322, they are still retained by the retainers 356 in the fixed torque receiver 320. Whereas the floating torque member 322 is maintained rotationally fixed by the torque force applied by the fastener to the shaft 318, the fixed torque receiver 320 and torque transfer member 324 rotate with the handle 312 due to the force being applied from the user. The torque transfer members 324 will rotate with the fixed torque receiver 320 and at some rotational point will engage the entrance portion 362 of the adjacent retainer 358 of the floating torque member 322. The helical ramp shape of the entrance portion 362 of the retainers 358 allows for a smoother entrance of the torque transfer members 324 into the retainers 358 of the floating torque member 322 so that the user of the torque transfer tool 310 does not experience a jarring force as the torque transfer members 324 engage the adjacent retainers 358 in the floating torque member 322. However, the user will hear an audible click to recognize that the rotational torque being applied by the user to the torque transfer tool 310 has exceeded the rating of the tool 310 and further rotation should be stopped (i.e., the fastener is properly set).

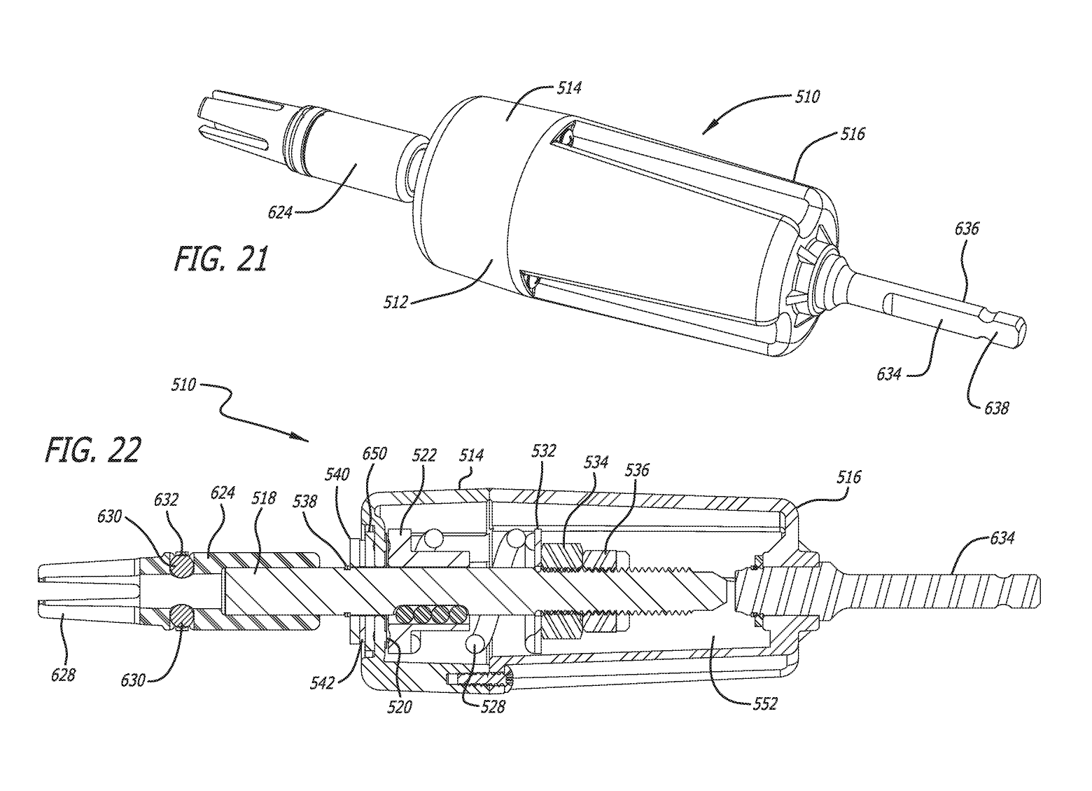

Another embodiment of a torque limiting tool 510 is illustrated in FIGS. 21-23. Many of the components of the first embodiment of FIGS. 1-6, second embodiment of FIGS. 7-12 and/or third embodiment of FIGS. 13-20, as well as the alternate components disclosed herein may be similarly incorporated in this embodiment, however, certain modifications are also incorporated. Like components from the first and second embodiments will have like 500 series reference numbers in this embodiment in the figures and the specification. It is understood throughout this specification that the components and structure identified in the different embodiments may be combined with other components and structure of any of the embodiments to arrive at an alternate torque limiting tool.

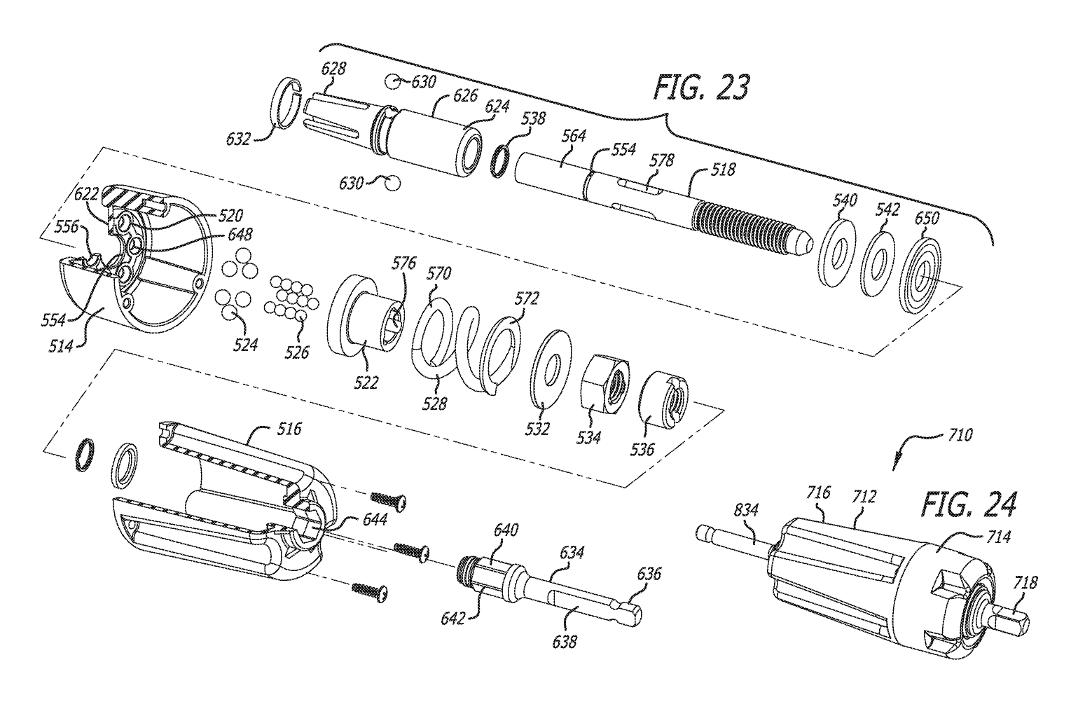

Referring to FIGS. 21-23, the impactor housing 512 of the torque limiter tool 510 comprises a front housing 514 and a rear housing 516, similar to the embodiment of FIG. 1, however, this embodiment of the torque limiter tool 510 also includes an input shaft 634 which provides the input torque to the housing 512 that was provided by a user turning the handle in the prior embodiments. The input shaft 634 has a first end 636 that may preferably be connected to an auxiliary driver (not shown). In one embodiment the first end 636 of the input shaft 634 has a flat 638 that mates with a matching surface in the auxiliary driver. The second end 640 of the input shaft 634 has a transmission member 642 that mates with a receiver 644 in the rear housing 516 and which is able to transmit torque that is received from the auxiliary driver to the rear housing 516. The input shaft 634 may be secured in place in the receiver 644 with a retaining ring, a nut, or any other fixing mechanism, including welding or swaging. As shown in FIG. 23, in one embodiment the rear housing 516 is fixed to the front housing 514, such as with screws 646.

Referring to FIG. 23, the fixed torque receiver 520 of this embodiment is similar to the fixed torque receiver 20 of FIG. 6, in that it is at least partially integral with and made a part of the front housing 514. Accordingly, the plurality of retainers 556 of the fixed torque receiver 520 of this embodiment are provided directly in the front housing 514. However, in one embodiment the fixed torque receiver 520 and the retainers 556 are not made up entirely of the front housing 514. In one embodiment the front housing 514 is made of a plastic material and the retainers 556 have an open back portion 648. To provide additional support for the plastic housing 514, a metal race 650 is provided on an exterior of the front housing 514. The metal race 650 operates as the back or bottom portion of the retainers 556, and further provides additional support for the torque transfer members 524. The metal race 650 is secured to the outside of the front housing 514 in a clamping manner when the shaft 518 is connected in place. Like the embodiment of FIG. 6, the shaft 518 may have a groove 555 in which a retaining ring 538 is secured. Additionally, a plurality of washers 540, 542, as in the first embodiment, are provided to assist in properly securing the shaft 518 and to also allow for proper rotation of the shaft 518 relative to the housing 512. Accordingly, similar to the first embodiment as shown in FIG. 2, referring to FIGS. 22 and 23 of this embodiment, axial or lateral inward motion of the shaft 518 into the cavity 552 of the housing 512 is prevented via the retaining ring 538 that is fixed to the shaft 518 and positioned in groove 555 in the shaft 518. The shaft 518 is further held in place from axial or lateral movement out of the cavity 552 through the opening 554 in the front housing 514 via the torque mechanism as described herein. The front housing 514 may also have a recess 622 to seat the washers 540, 542.

As shown in FIGS. 22 and 23, the floating torque member 522 of this embodiment is similar to the floating torque member 22 of the first embodiment, where the diameter of the floating torque member 522 at the first surface 598 is larger than the diameter of the floating torque member 522 at the second surface 599. Unlike the prior embodiments which generally employ two retainers 30, 32 and 330, 332, in this embodiment only one retainer 532 may be required, and the first end 570 of the spring member 528 may directly engage and push against the floating torque member 522. Retainer 532 is preferably provided at the send end 572 of the spring member 528 against which the locking member 534 may engage. The further the locking member 534 is moved toward the fixed torque receiver 520 to further compress the spring member 528, the greater the force operating to maintain the floating torque member 522 in rotational engagement with the fixed torque receiver 520, and the higher the torque rating of the torque limiter tool 510.

Another variation in this embodiment is that, similar to the third embodiment of FIGS. 13-20, rather than having the output end 564 of the drive shaft 518 directly engage a fastener, such as, for example, a screw to be inserted into an implant, the output end 564 of the drive shaft 518 may allow for securement of a quick-release member 624 to the drive shaft 518. The quick release member 624 may secure a tool (not shown) thereto, where the tool can then be mated with the fastener manipulating the fastener. As explained above, by having a quick release member 624 a variety of different tools may be utilized with the same torque limiter tool 510. In one embodiment the quick release member 624 comprises a quick release body 626 having a plurality of fingers 628 to retain the tool, a plurality of ball bearings 630 and a c-clamp 632. By moving the release body 626 the ball bearings 630 can be allowed to move radially outwardly, while still being held by the c-clamp, for insertion and removal of the tool. Then, when the release body 626 is put back in its normal position the ball bearings 630 cannot be moved and the tool will be fixed in place.

Use of this embodiment of the torque limiting tool 510 is similar to the use of the torque limiting tools 10, 110, 310 of the prior embodiments. For example, in the example where the fastener is a screw and the screw is being screwed into an implant, to rotate the fastener and therefore set the fastener into the implant, in this example, an auxiliary driver (not shown) is connected to the input shaft 634 of the torque limiter 510. Additionally, a tool is placed in the quick release member 624 at the output end 564 of the drive shaft 518 of the torque limiter 510. As the auxiliary driver rotates, the input shaft 634 similarly rotates and the handle 512 is turned or rotated via the drive connection between the transmission member 642 of the input shaft 634 that mates with a receiver 644 in the rear housing 516. As with the prior embodiments, rotation of the handle 512 causes rotation of the fixed torque receiver 520, which in turn causes simultaneous rotation of the floating torque member 522, which in turn causes simultaneous rotation of the shaft 518, including rotation of the output end 564 of the shaft 518 and the quick release member 624 connected thereto and tool therein. Specifically, the fixed torque receiver 520 is rotationally locked to the floating torque member 522 with the plurality of torque transfer members 524 via the spring force applied to the floating torque member 522 from the spring member 528. And, the floating torque member 522 is rotationally locked to the shaft 518 via the longitudinal transfer members 526 between the shaft 518 and the floating torque member 522. Therefore, when the input shaft 634 is rotated the fastener will similarly be rotated, such as for example, to rotate or screw the fastener into the implant.

During rotation of the fastener into the implant the torque limiter tool 510 applies a torque to the fastener through the drive shaft 518 of the torque limiter tool 510. As the torque is applied by the torque limiter tool 510, a resistance force is observed by the torque limiter tool 510. When the resistance force requires the torque limiter tool 510 to exceed the torque rating of the torque limiter tool 510, the floating torque member 522 will disengage from the fixed torque member 520. Continued rotation of the handle 512 by the user, which equates to an input torque force, will cause the torque transfer members 524 positioned in the retainers 556 of the fixed torque receiver 520 to become displaced from their position in the retainers 558 of the floating torque member 522, thereby causing the floating torque member 522 to axially move toward the locking member 534 by compressing the spring member 528. The spring member 528 will only be compressed, i.e., the floating torque member 522 will only move axially toward the locking member 534, when the torque being applied to the fastener by the torque limiter tool 510 exceeds the amount of force applied by the spring member 528 to maintain the floating torque member 522 in rotational engagement with the fixed torque receiver 520. When the torque transfer members 524 are displaced from their position in the retainers 558 of the floating torque member 522, they are still retained by the retainers 556 in the fixed torque receiver 520. Whereas the floating torque member 522 is maintained rotational fixed by the torque force applied by the fastener to the shaft 518, the fixed torque receiver 520 and torque transfer member 524 rotate with the handle 512 due to the force being applied from the input shaft 634. The torque transfer members 524 will rotate with the fixed torque receiver 520 and at some rotational point will engage the entrance portion 562 of the adjacent retainer 558 of the floating torque member 522. The user will recognize that the rotational torque being applied to the torque transfer tool 510 has exceeded the rating of the tool 510 and further rotation should be stopped (i.e., the fastener is properly set).

Another embodiment of a torque limiting tool 710 is illustrated in FIGS. 24-30. Many of the components of the first embodiment of FIGS. 1-6, second embodiment of FIGS. 7-12, third embodiment of FIGS. 13-20 and/or fourth embodiment of FIGS. 21-23, as well as the alternate components disclosed herein may be similarly incorporated in this embodiment, however, certain modifications are also incorporated. Like components from the first, second and third embodiments will have like 700/800 series reference numbers in this embodiment in the figures and the specification. It is understood throughout this specification that the components and structure identified in the different embodiments may be combined with other components and structure of any of the embodiments to arrive at an alternate torque limiting tool.

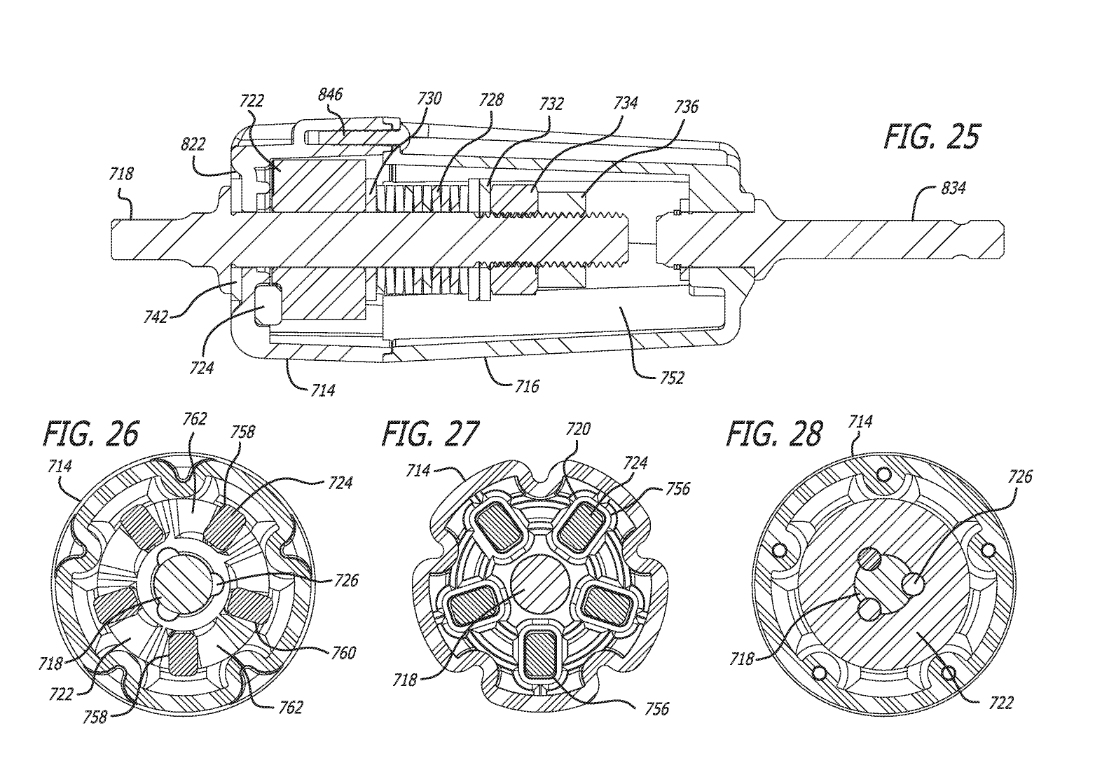

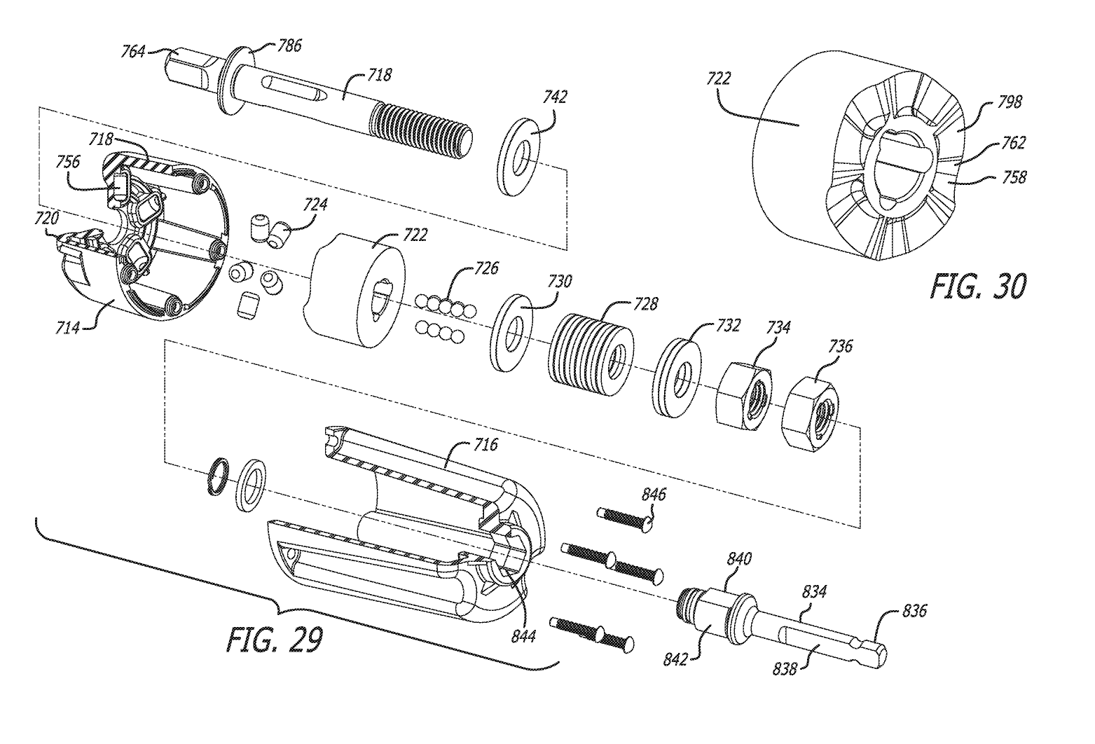

Referring to FIGS. 24-30, the impactor housing 712 of the torque limiter tool 710 comprises a front housing 714, a rear housing 716, and an input shaft 834 which provides the input torque to the housing 712 similar to the embodiment of FIG. 21. The input shaft 834 has a first end 836 that may preferably be connected to an auxiliary driver (not shown). In one embodiment, as shown in FIGS. 25 and 29, the first end 836 of the input shaft 834 has a flat 838 that mates with a matching surface in the auxiliary driver. The second end 840 of the input shaft 834 has a transmission member 842 that mates with a receiver 844 in the rear housing 716 and which is able to transmit torque that is received from the auxiliary driver to the rear housing 716. The input shaft 834 may be secured in place in the receiver 844 with a retaining ring, a nut (as shown in FIG. 29), or any other fixing mechanism, including welding or swaging. As shown in FIG. 29, in one embodiment the rear housing 716 is fixed to the front housing 714, such as with screws 846.

Referring to FIGS. 27 and 29, the fixed torque receiver 720 of this embodiment is similar to the fixed torque receiver 20 of FIG. 6 and the fixed torque receiver 520 of FIG. 23, in that it is at least partially integral with and made a part of the front housing 714. Accordingly, the plurality of retainers 756 of the fixed torque receiver 720 of this embodiment are provided directly in the front housing 714.

However, a variation in this embodiment from the prior embodiments is that while the connection between the fixed torque receiver 720 and the floating torque member 722 is made via a plurality of torque transfer members 724, the torque transfer members 724 are made of elongated cylindrical members 724, such as pins 724 or needle bearings 724, rather than being comprised of ball bearings as in the prior embodiments. Accordingly, the retainers 756 in the fixed torque receiver 720 will be shaped and sized more rectangularly to seat the elongated cylindrical members 724. The use of elongated cylindrical members 724 allows for more contact area between the torque transfer members 724 and the floating torque member 722 than with the use of ball bearings. This is because the cylindrical members 724 generally have a line contact with the fixed torque receiver 720 and the floating torque member 722, whereas the ball bearings likely have a contact between the components that is closer to a point contact. The use of line contact between the components distributes the spring forces over a larger area, which reduces stress on the materials. Additionally, a line contact between surfaces helps to reduce friction between the fixed and floating disk.

In a preferred embodiment, the floating torque member 722 includes a plurality of retainers 758 for retaining a portion of the torque transfer members 724. In one embodiment the retainers 756, while being generally rectangular in cross-sectional shape, are provided in an annular configuration at a fixed radial distance from a center of the fixed torque receiver 720. Similarly, the retainers 758 of the floating torque member 722 are preferably provided in the same annular configuration at the same fixed radial distance from a center of the floating torque member 722. The torque transfer members 724 are therefore retained between the fixed torque receiver 720 and the floating torque receive 722 within the respective retainers 756, 758.

Referring to FIG. 27, in one embodiment the retainers 756 of the fixed torque receiver 720 for the elongated cylindrical members 724 generally comprise a mating generally elongated rectangular cross-sectional shape with a cylindrical depth (i.e., a semi-cylindrical shape), such depth being preferably half or less of the diameter of the overall cylinder, to seat the cylindrical torque transfer members 724. The seating of the torque transfer members 724 in the retainers 756 of the fixed torque receiver 720, including the cross-sectional shape of one embodiment of the retainers 756 and the torque transfer members 724 is further seen in cross-section in FIG. 25.

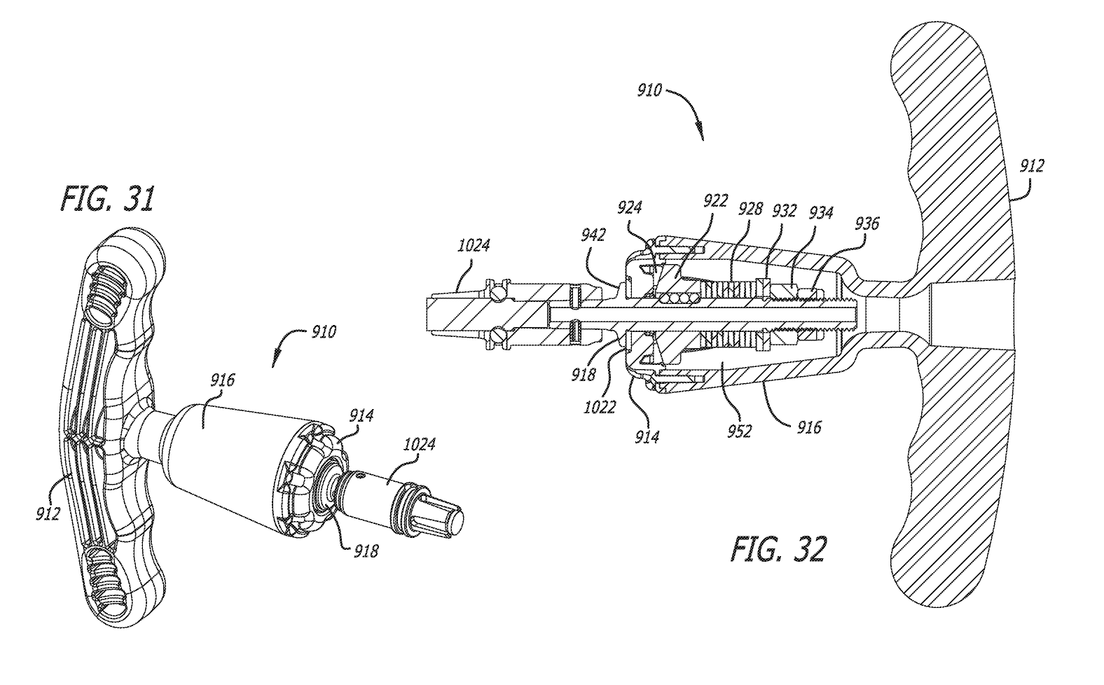

The retainers 758 of the floating torque member 722 may have a similar geometry to the retainers 756 of the fixed torque receiver 720. Alternately, the retainers 758 of the floating torque member 722 may have a partially similar geometry and a partially dissimilar geometry to the geometry of the retainers 756 of the fixed torque receiver 720. For example, as shown in the embodiment of FIGS. 26 and 30, the retainers 758 of the floating torque member 722 may have a semi-cylindrical shape component 760 and an entrance portion 762 to the semi-cylindrical shape component 760 of the retainer 758. In a preferred embodiment the entrance portion 762 of the retainer 758 of the floating torque member 722 may have a ramp shape, such as a helical ramp shape, about the annular geometry in which the retainers 758 are positioned. As explained herein, the helical ramp shape of the entrance portion 762 of the retainers 758 allows for a smoother entrance of the torque transfer members 724 into the retainers 758 of the floating torque member 722. In an alternate embodiment, the exit portion of the retainers 758 may also have a bevel or partial ramp portion, which is generally much shorter/smaller than the ramp portion at the entrance portion 762 to allow for a less “jerky” exit of the torque transfer members 724 from the retainers 758. Accordingly, in different embodiments the entrance and exit ramps to the retainers 758 can be unidirectional, meaning the entrance portion 762 and exit portion of the retainers 758 is not symmetrical and a ramp is provided at the entrance to the retainers 758 or bidirectional, meaning the entrance portion 762 and exit portion of the retainers 758 both have some sort of lead in, however the lead in may not be the same shape. Additionally, there can be a variation to the ramp angle to vary the torque range/setting and to minimize back lash torque (reverse torque) during use.

As shown in FIGS. 29 and 30, the floating torque member 722 of this embodiment is similar to the floating torque member 122 of the second embodiment, where the diameter of the floating torque member 722 at the first surface 798 is generally the same as the diameter of the floating torque member 722 at the second surface 799.

As with the prior embodiment, this embodiment incorporates a drive shaft 718. This embodiment of the drive shaft 718 may include an output end 764 that does not directly engage a fastener. Instead, a separate tool or quick release member (not shown) may be connected to the output end 764 of the drive shaft 718. Similar to the embodiment of FIG. 15, axial or lateral inward motion of the drive shaft 718 into the cavity 752 of the housing 712 is prevented via a shoulder 786 extending from the drive shaft 718. The shaft 718 is further held in place from axial or lateral movement out of the cavity 752 through the opening 754 in the front housing 714 via the torque mechanism as described herein. The front housing 714 may also have a recess 822 to seat one or more washers 742 between the front housing 714 and the shoulder 786 of the drive shaft 718.

In the present embodiment the torque mechanism generally comprises the fixed torque receiver 720, which in this embodiment is integral with the front housing 714, the floating torque member 722, the plurality of torque transfer members 724, the plurality of longitudinal transfer member 726, a locking member 734 and a spring member 728. One difference being, however, that rather than incorporating a compression spring as the spring member 728, the spring member 728 is comprised of a plurality of force-generating members (i.e., Belleville washers). Additionally, washers 730, 732 may be provided on opposite ends of the spring member 728.

Use of this embodiment of the torque limiting tool 710 is similar to the use of the torque limiting tools 10, 110, 310, 510 of the prior embodiments. For example, in the example where the fastener is a screw and the screw is being screwed into an implant, to rotate the fastener and therefore set the fastener into the implant, in this example, an auxiliary driver (not shown) is connected to the input shaft 834 of the torque limiter 710. Additionally, a tool or quick release member is connected to the output end 764 of the drive shaft 718 of the torque limiter 710. As the auxiliary driver rotates, the input shaft 834 similarly rotates and the handle 712 is turned or rotated via the drive connection between the transmission member 842 of the input shaft 834 that mates with a receiver 744 in the rear housing 716. As with the prior embodiments, rotation of the handle 712 causes rotation of the fixed torque receiver 720, which in turn causes simultaneous rotation of the floating torque member 722, which in turn causes simultaneous rotation of the shaft 718, including rotation of the output end 764 of the shaft 718 and the quick release member/tool connected thereto. Specifically, the fixed torque receiver 720 is rotationally locked to the floating torque member 722 with the plurality of torque transfer members 724 via the spring force applied to the floating torque member 722 from the spring members 728. And, the floating torque member 722 is rotationally locked to the shaft 718 via the longitudinal transfer members 726 between the shaft 718 and the floating torque member 722. Therefore, when the input shaft 834 is rotated the fastener will similarly be rotated, such as for example, to rotate or screw the fastener into the implant.

During rotation of the fastener into the implant the torque limiter tool 710 applies a torque to the fastener through the drive shaft 718 of the torque limiter tool 710. As the torque is applied by the torque limiter tool 710, a resistance force is observed by the torque limiter tool 710. When the resistance force requires the torque limiter tool 710 to exceed the torque rating of the torque limiter tool 710, the floating torque member 722 will disengage from the fixed torque member 720. Continued rotation of the handle 712 by the user, which equates to an input torque force, will cause the torque transfer members 724 positioned in the retainers 756 of the fixed torque receiver 720 to become displaced from their position in the retainers 758 of the floating torque member 722, thereby causing the floating torque member 722 to axially move toward the locking member 734 by compressing the spring members 728. The spring members 728 will only be compressed, i.e., the floating torque member 722 will only move axially toward the locking member 734, when the torque being applied to the fastener by the torque limiter tool 710 exceeds the amount of force applied by the spring members 728 to maintain the floating torque member 722 in rotational engagement with the fixed torque receiver 720. When the torque transfer members 724 are displaced from their position in the retainers 758 of the floating torque member 722, they are still retained by the retainers 756 in the fixed torque receiver 720. Whereas the floating torque member 722 is maintained rotationally fixed by the torque force applied by the fastener to the shaft 718, the fixed torque receiver 720 and torque transfer member 724 rotate with the handle 712 due to the force being applied from the input shaft 834. The torque transfer members 724 will rotate with the fixed torque receiver 720 and at some rotational point will engage the entrance portion 762 of the adjacent retainer 758 of the floating torque member 722. The user will recognize that the rotational torque being applied to the torque transfer tool 710 has exceeded the rating of the tool 710 and further rotation should be stopped (i.e., the fastener is properly set).

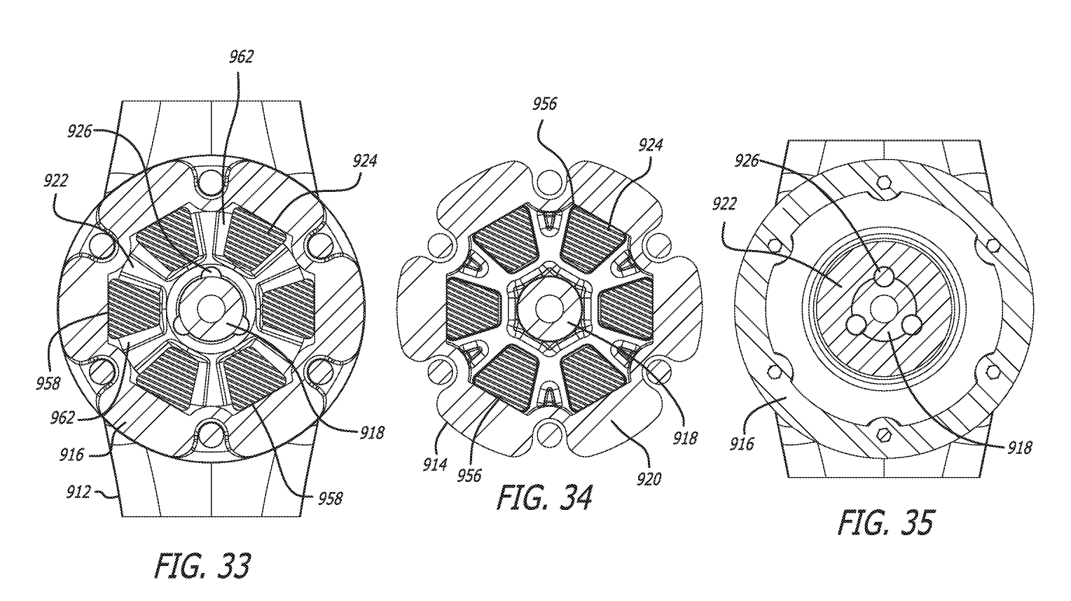

Another embodiment of a torque limiting tool 910 is illustrated in FIGS. 31-38. Many of the components of the first embodiment of FIGS. 1-6, second embodiment of FIGS. 7-12, third embodiment of FIGS. 13-20, fourth embodiment of FIGS. 21-23 and/or fifth embodiment of FIGS. 24-30, as well as the alternate components disclosed herein may be similarly incorporated in this embodiment, however, certain modifications are also incorporated. Like components from the first, second and third embodiments will have like 900/1000 series reference numbers in this embodiment in the figures and the specification. It is understood throughout this specification that the components and structure identified in the different embodiments may be combined with other components and structure of any of the embodiments to arrive at an alternate torque limiting tool.

Referring to FIGS. 29-32 and 36, in this embodiment the torque limiter 910 generally comprises an impactor housing 912, which may comprise a front housing 914 and a rear housing 916 (similar to the housing of the embodiment shown in FIGS. 13-15), a shaft 918, a fixed torque receiver 920, a floating torque member 922, a plurality of torque transfer members 924, a plurality of longitudinal transfer member 926 that are positioned between the floating torque member 922 and the shaft 918, a spring member 928, a first locking member or nut 934, and a second or locking/jam nut 936. This embodiment also includes a quick release member 1024 connected to the output end 964 of the drive shaft 918.

A variation in this embodiment from the prior embodiments is that while the connection between the fixed torque receiver 920 and the floating torque member 922 is made via a plurality of torque transfer members 924, the torque transfer members 924 are made of tapered cylindrical members 924, such as tapered pins 924 or tapered needle bearings 924, rather than as ball bearings or straight cylindrical pins as in the prior embodiments. Accordingly, the retainers 956 in the fixed torque receiver 920 will be shaped and sized like a v-shaped wedge to seat the tapered cylindrical members 924. The tapered pins 924 have a first diameter at one end of the pin and a second diameter at the opposing end of the pin, where the second diameter is larger than the first diameter. In a preferred embodiment, the taper is linear from the first diameter at the first end to the second diameter at the second end. The use of tapered cylindrical members 924 allows for more contact area between the torque transfer members 924 and the floating torque member 922 than with the use of ball bearings, similar to the elongated cylindrical members 724 of the prior embodiment. This is because the tapered cylindrical members 924 generally have a line contact with the fixed torque receiver 920 and the floating torque member 922, whereas the ball bearings likely have a contact between the components that is closer to a point contact. The use of line contact between the components distributes the spring forces over a larger area, which reduces stress on the materials. Additionally, a line contact between surfaces helps to reduce friction between the fixed and floating disk. However, the tapered cylindrical members 924 have an advantage over the elongated straight cylindrical members 724. As the fixed torque receiver 920 and floating torque member 922 rotate, the inside and outside (from the centerline axis) of the components rotate at different rates because of being at different radial distances from the centerline. A benefit of the tapered pin 924 is that as the fixed torque receiver 920 rotates, the inner/outer contact surface of the tapered pin 924 will rotate at the same rate, unlike the cylindrical pin 724 where the inner/outer contact surface will want to rotate at different rates. By incorporating the tapered pins 924 one can reduce drag/friction observed by the straight pin 724. Specifically, as the tapered pin 924 travels up the helical ramp 962 of the retainers 958 in the floating torque member 922, the inside and outside rotation of the tapered pin 924 will be consistent allowing it to rotate up the ramp 962 versus the straight pins 724 that tend to slide up the ramp 762 due to different rotation rates.

In a preferred embodiment, the floating torque member 922 includes a plurality of retainers 958 for retaining a portion of the torque transfer members 924. In one embodiment the retainers 956, are generally V-shaped in cross-sectional shape, and are provided in an annular configuration at a fixed radial distance from a center of the fixed torque receiver 920. Similarly, the retainers 958 of the floating torque member 922 are preferably provided in the same annular configuration at the same fixed radial distance from a center of the floating torque member 922. The torque transfer members 924 are therefore retained between the fixed torque receiver 920 and the floating torque receive 922 within the respective retainers 956, 958.

Referring to FIG. 34, in one embodiment the retainers 956 of the fixed torque receiver 920 for the tapered cylindrical members 924 generally comprise a mating V-shaped cross-sectional shape with a tapered cylindrical depth, such depth being preferably half or less of the diameter of the mating tapered pin 924, to seat the tapered cylindrical torque transfer members 924.

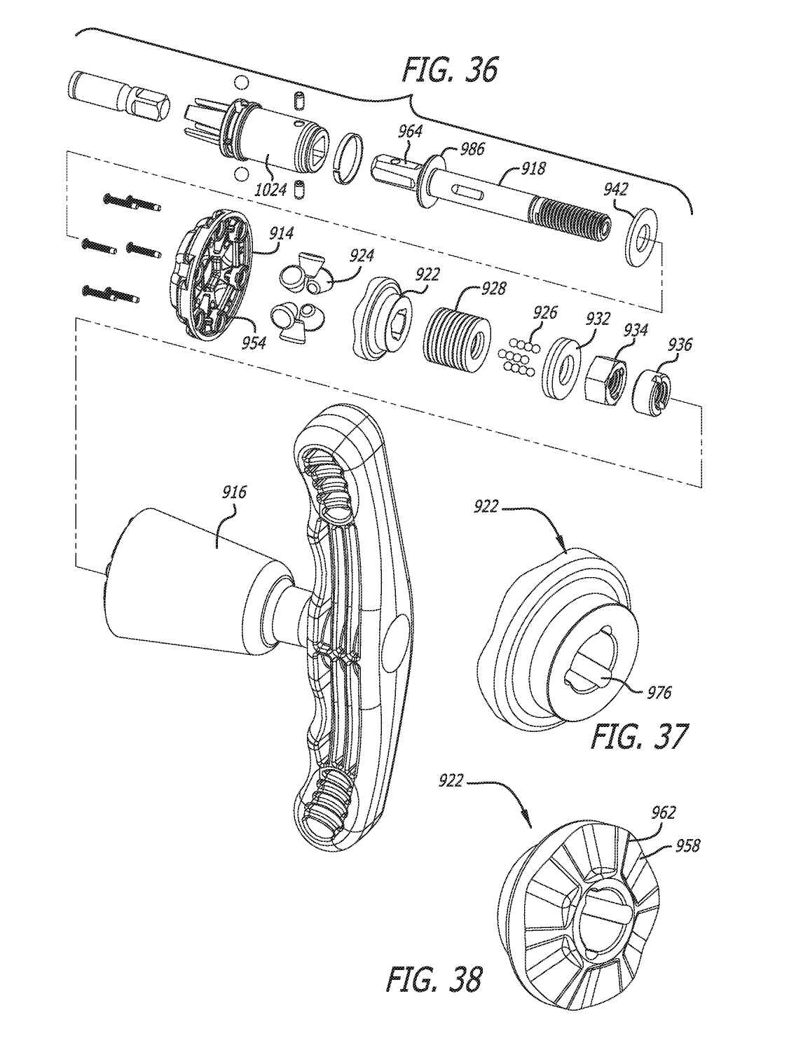

The retainers 958 of the floating torque member 922 may have a similar geometry to the retainers 956 of the fixed torque receiver 920. Alternately, the retainers 958 of the floating torque member 922 may have a partially similar geometry and a partially dissimilar geometry to the geometry of the retainers 956 of the fixed torque receiver 920. For example, as shown in the embodiment of FIGS. 36-38, the retainers 958 of the floating torque member 922 may have a tapered semi-cylindrical shape component 960 and an entrance portion 962 to the tapered semi-cylindrical shape component 960 of the retainer 958. In a preferred embodiment the entrance portion 962 of the retainer 958 of the floating torque member 922 may have a ramp shape, such as a helical ramp shape, about the annular geometry in which the retainers 958 are positioned. As explained herein, the helical ramp shape of the entrance portion 962 of the retainers 958 allows for a smoother entrance of the torque transfer members 924 into the retainers 958 of the floating torque member 922. Alternate configurations of the entrance and exit portions as previously described herein may also be employed in this embodiment.

As with the prior embodiment, this embodiment incorporates a drive shaft 918. Like the prior embodiment, this embodiment of the drive shaft 918 may include an output end 964 that does not directly engage a fastener. Instead, a quick release member 1024 may be connected to the output end 964 of the drive shaft 918. Similar to the embodiment of FIG. 29, axial or lateral inward motion of the drive shaft 918 into the cavity 952 of the housing 912 is prevented via a shoulder 986 extending from the drive shaft 918. The shaft 918 is further held in place from axial or lateral movement out of the cavity 952 through the opening 954 in the front housing 914 via the torque mechanism as described herein. The front housing 914 may also have a recess 1022 to seat one or more washers 942 between the front housing 914 and the shoulder 986 of the drive shaft 918.

In this embodiment the torque mechanism generally comprises the fixed torque receiver 920, which in this embodiment is integral with the front housing 914, the floating torque member 922, the plurality of torque transfer members 924, the plurality of longitudinal transfer member 926, a locking member 934 and a spring member 928. As with the prior embodiment, the spring member 928 is comprised of a plurality of force-generating members (i.e., Belleville washers). Additionally, washers 932 may be provided at the end of the spring member 928.

Use of this embodiment of the torque limiting tool 910 is similar to the use of the torque limiting tools 10, 110, 310, 510, 710 of the prior embodiments. For example, in the example where the fastener is a screw and the screw is being screwed into an implant, to rotate the fastener and therefore set the fastener into the implant, in this example, a quick release member is connected to the output end 964 of the drive shaft 918 of the torque limiter 910. As the user rotates the handle 912 this causes rotation of the fixed torque receiver 920, which in turn causes simultaneous rotation of the floating torque member 922, which in turn causes simultaneous rotation of the shaft 918, including rotation of the output end 964 of the shaft 918 and the quick release member/tool connected thereto. Specifically, the fixed torque receiver 920 is rotationally locked to the floating torque member 922 with the plurality of torque transfer members 924 via the spring force applied to the floating torque member 922 from the spring members 928. And, the floating torque member 922 is rotationally locked to the shaft 918 via the longitudinal transfer members 926 between the shaft 918 and the floating torque member 922.

During rotation of the fastener into the implant the torque limiter tool 910 applies a torque to the fastener through the drive shaft 918 of the torque limiter tool 910. As the torque is applied by the torque limiter tool 910, a resistance force is observed by the torque limiter tool 910. When the resistance force requires the torque limiter tool 910 to exceed the torque rating of the torque limiter tool 910, the floating torque member 922 will disengage from the fixed torque member 920. Continued rotation of the handle 912 by the user, which equates to an input torque force, will cause the torque transfer members 924 positioned in the retainers 956 of the fixed torque receiver 920 to become displaced from their position in the retainers 958 of the floating torque member 922, thereby causing the floating torque member 922 to axially move toward the locking member 934 by compressing the spring members 928. The spring members 928 will only be compressed, i.e., the floating torque member 922 will only move axially toward the locking member 934, when the torque being applied to the fastener by the torque limiter tool 910 exceeds the amount of force applied by the spring members 928 to maintain the floating torque member 922 in rotational engagement with the fixed torque receiver 920. When the torque transfer members 924 are displaced from their position in the retainers 958 of the floating torque member 922, they are still retained by the retainers 956 in the fixed torque receiver 920. Whereas the floating torque member 922 is maintained rotational fixed by the torque force applied by the fastener to the shaft 918, the fixed torque receiver 920 and torque transfer member 924 rotate with the handle 912. The torque transfer members 924 will rotate with the fixed torque receiver 920 and at some rotational point will engage the entrance portion 962 of the adjacent retainer 958 of the floating torque member 922. The user will recognize that the rotational torque being applied to the torque transfer tool 910 has exceeded the rating of the tool 910 and further rotation should be stopped (i.e., the fastener is properly set).

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the disclosed technology may be embodied in other specific forms without departing from the spirit or central characteristics thereof. The present examples and embodiments, therefore, are to be considered in all respects as illustrative and not restrictive, and the disclosed technology is not to be limited to the details given herein. Accordingly, while the specific embodiments have been illustrated and described, numerous modifications come to mind without significantly departing from the spirit of the disclosed technology and the scope of protection is only limited by the scope of the accompanying Claims.

What is claimed is:

1. A torque limiter assembly comprising:
a housing;
a fixed torque member having a plurality of first retainers;
a floating torque member having a plurality of second retainers;
a plurality of torque transfer members between the first torque member and the floating torque member, the torque transfer members at least partially seated at times in the first and second retainers;
a shaft;
a plurality of longitudinal transfer members between the floating torque member and the shaft, the longitudinal transfer members rotationally fixing the floating torque member to the shaft but allowing axial movement of the floating torque member;
a spring member providing a force on the floating torque member to, at times, rotationally fix the floating torque member to the fixed torque member; and,
a locking mechanism to adjust the force of the spring member on the floating torque member.

2. The torque limiter assembly of claim 1, wherein the torque transfer members comprise tapered cylindrical members.

3. The torque limiter assembly of claim 2, wherein the tapered cylindrical members have a first diameter at a first end of the cylindrical member and a second diameter at an opposing end of the cylindrical member, and wherein the second diameter is larger than the first diameter.

4. The torque limiter assembly of claim 1, wherein the torque transfer members comprise ball bearings.

5. The torque limiter assembly of claim 1, wherein the shaft extends through the fixed torque receiver and the floating torque receiver.

6. The torque limiter assembly of claim 1, further comprising an axial groove in the shaft to seat the longitudinal transfer members.

7. The torque limiter assembly of claim 1, wherein the spring member comprises a plurality of force-generating members.

8. The torque limiter assembly of claim 7, wherein the force-generating members comprise Belleville washers.

9. The torque limiter assembly of claim 1, wherein the second retainers of the floating torque member have a helical ramp entrance thereto.

10. The torque limiter assembly of claim 1, wherein the torque transfer members are rotatable between the fixed torque member and the floating torque member.

11. The torque limiter assembly of claim 1, wherein the first retainers are integral with the housing.

12. A torque limiter assembly comprising:
a housing;
a first torque member having a plurality of first retainers;
a second torque member having a plurality of second retainers; and,
a plurality of rotatable torque transfer members between the first torque member and the second torque member, the rotatable torque transfer members at least partially seated at times in the first and second retainers, wherein the rotatable torque transfer members are tapered and have a first diameter at a first end thereof and a second diameter at an opposing end thereof, and wherein the second diameter is larger than the first diameter.

13. The torque limiter assembly of claim 12, wherein the torque transfer members comprise tapered cylindrical members.

14. The torque limiter assembly of claim 12, wherein the first torque member is fixed to the housing and wherein the second torque member is capable of moving axially with respect to the housing.

15. The torque limiter assembly of claim 12, further comprising:
a shaft;
a plurality of longitudinal transfer members between the second torque member and the shaft, the longitudinal transfer members rotationally fixing the second torque member to the shaft but allowing axial movement of the second torque member;
a spring member providing a force on the second torque member to, at times, rotationally fix the second torque member to the first torque member; and,
a locking mechanism to adjust the force of the spring member on the second torque member.

16. A torque limiter assembly comprising:
a fixed torque member;
a floating torque member adjacent the fixed torque member;
a shaft; and,
a plurality of longitudinal transfer members between the floating torque member and the shaft, the longitudinal transfer members rotationally fixing the floating torque member to the shaft but allowing axial movement of the floating torque member.

17. The torque limiter assembly of claim 16, wherein the longitudinal transfer members comprise ball bearings, wherein the shaft has an external longitudinal groove to partially seat the longitudinal transfer members, and wherein the floating torque member has at least one internal longitudinal groove to partially receive the longitudinal transfer members.

18. The torque limiter assembly of claim 16, wherein the fixed torque member has a plurality of first retainers, and wherein the floating torque member has a plurality of second retainers.

19. The torque limiter assembly of claim 16, further comprising a plurality of torque transfer members between the first torque member and the floating torque member, the torque transfer members at least partially seated at times in the first and second retainers.

20. The torque limiter assembly of claim 19, further comprising a spring member providing a force on the floating torque member to, at times, rotationally fix the floating torque member to the fixed torque member, and a locking mechanism to adjust the force of the spring member on the floating torque member.
